(19) United States
(12) Patent Application Publication
(10) Pub. No.: US 2005/0148236 A1
(43) Pub. Date: Jul. 7, 2005

(54) Connector and method of operation

(76) Inventor: Noah P. Montena, Syracuse, NY (US)

Correspondence Address: ARLEN L. OLSEN;SCHMEISER, OLSEN & WATTS, 3 LEAR JET LANE, SUITE 201, LATHAM, NY, 12110, US

(21) Appl. No.: 10/971,442

(22) Filed: Dec. 7, 2004

Related U.S. Application Data
(63) Continuation of application No. 10/348,652, filed on Jan. 21, 2003, now Pat. No. 6,848,940.
Application No. 10/348,652 is a continuation of application No. 09/621,975, filed on Jul. 21, 2000, now Pat. No. 6,558,194.
Application No. 09/621,975 is a continuation of application No. 08/910,509, filed on Aug. 2, 1997, now Pat. No. 6,153,830.

(51) Int. Cl. H01R 9/05

(52) U.S. Cl. 439/578

(57) ABSTRACT

A connector includes a fastener member and a single-body structured connector body having an exterior casing and integral interior post. The structuring of the connector body facilitates improved RF shielding and reduction of noise ingress into the connector. In one embodiment, a coaxial cable having a center conductor, a dielectric, a braided sheath, and a protective outer jacket is inserted onto the connector. The fastener member, in a pre-installed first configuration is slidably advanced onto the connector body and moved into a second configuration in which the fastener member coacts with the connector body so that the connector sealingly grips the coaxial cable. A threaded nut may be used to secure the connector to an interface port.

### CROSS-REFERENCE TO RELATED APPLICATIONS

This application is a continuation in part of application Ser. No. 10/348,652, filed Jan. 21, 2003, currently pending, which is a continuation of Ser. No. 09/621,975, filed on Jul. 21, 2000, now U.S. Pat. No. 6,676,446, which is a continuation of Ser. No. 08/910,509, filed on Aug. 2, 1997, now U.S. Pat. No. 6,153,830.

### FIELD OF THE INVENTION

This invention relates to connectors used to couple cables to equipment ports, terminals, or the like. The invention is particularly useful in, although not limited to, universal connectors for coaxial cables of the type employed in the cable television industry.

### BACKGROUND OF THE INVENTION

In using electronic devices such as televisions and video tape machines, it is desired to connect such devices either together or to other sources of electronic signals. Typically, a television may be hooked up to a cable service that enters the home through coaxial cables. Such cables are connected to the television by use of one or more connectors.

The conventional coaxial cable typically contains a centrally located electrical conductor surrounded by and spaced inwardly from an outer cylindrical braid conductor. The center and braid conductors are separated by a foil and an insulator core, with the braid being encased within a protective sheathing jacket. In some typical coaxial cables, a foil layer is not used such that the outer braid conductor surrounds the insulator core.

Conventional coaxial cable end connectors typically include an inner cylindrical post adapted to be inserted into a suitably prepared end of the cable between the foil and the outer braid conductor, an end portion of the latter having been exposed and folded back over the sheath jacket. The center conductor, the insulator core, and the foil thus form a central core portion of the cable received axially in the inner post, whereas the outer braid conductor and sheathing jacket comprise an outer portion of the cable surrounding the inner post.

The conventional coaxial cable end connector further includes an outer component designed to coact with an inner post in securely and sealingly clamping the outer portion of the cable therebetween. In “crimp type” end connectors, the outer component is a connector body fixed in relation to and designed to be deformed radially inwardly towards the inner post by a crimping tool. Typical examples of crimp type end connectors are described in U.S. Pat. No. 5,073,129 (Szegda); U.S. Pat. No. 5,083,943 (Tarrant); and U.S. Pat. No. 5,501,616 (Holliday), which are incorporated herein in their entirety.

In the so-called “radial compression type” end connectors, the outer component is a substantially non-deformable sleeve adapted to be shifted axially with respect to the inner post into a clamped position coacting with the inner post to clamp the prepared cable end therebetween. Typical examples of radial compression type connectors are described in U.S. Pat. No. 3,710,005 (French); U.S. Pat. No. 4,676,577 (Szegda); and U.S. Pat. No. 5,024,606 (Yeh Ming-Hwa), which are incorporated herein in their entirety.

These radial compression type end connectors suffer from a common disadvantage in that prior to being mounted on the cable ends, the outer sleeve components are detached and separated from the inner post and/or connector members. As such, the outer sleeve components are prone to being dropped or otherwise becoming misplaced or lost, particularly, as is often the case, when an installation is being made outdoors under less than ideal weather conditions.

In other attempts, connectors have been made by detachably interconnecting the connector body and outer sleeve component in a parallel side-by-side relationship. This is intended to facilitate pre-installation handling and storage. However, during installation, the outer sleeve component must still be detached from the connector body and threaded or inserted onto the cable as a separate element. Thus, mishandling or loss of the outer sleeve component remains a serious problem during the critical installation phase.

U.S. Pat. No. 5,295,864 (Birch et al), which is also incorporated herein in its entirety, discloses a radial compression type end connector with an integral outer sleeve component. Here, however, the outer sleeve component is shifted into its clamped position as a result of the connector being threaded onto an equipment port or the like. Before the clamped position is achieved, the end connector is only loosely assembled on and is thus prone to being dislodged from the cable end. This again creates problems for the installer.

Another shortcoming of known connectors is the need for an O-ring or similar sealing member to prevent moisture from penetrating the end connector between the connector body and the outer sleeve component. Moreover, known connectors necessarily utilizing O-rings to form moisture preventive seals have problems resulting from O-rings that become damaged prior to connector installation. Furthermore, known connectors employing O-rings create installation problems because the O-rings may become dislodged and/or lost prior to connector installation. Additionally, the O-rings constitute additional components that add to increased manufacturing and assembly costs related to known connector fabrication. An example of a connector employing O-rings is disclosed in U.S. Pat. No. 5,470,257 (Szegda), which is also incorporated herein in its entirety, and makes known a radial compression type end connector having a connector body comprising a tubular inner post and requiring a fastener including a tubular locking protrusion working in conjunction with an O-ring to create a sealed connection.

Accordingly, there is a continued need for improved connectors in view of the problems associated with known connectors, and which may be utilized with a wide range of cable types and sizes. In addition, there is continued need for improved connectors that are relatively uncomplicated in structure and which are economical to fabricate.

### SUMMARY OF THE INVENTION

The present invention is directed to a connector comprising body member including a post member defining an inner first cavity, and further including a connector body coupled to the post member and defining therebetween an outer first cavity, the post member having a first opening and a second opening each communicating with the inner first cavity, and the connector body having at least one opening communicating with said outer first cavity; and fastener member defining a second cavity and having a first opening and a second opening each communicating with the second cavity, at least a portion of the fastener member being movably disposed on the connector body in a first configuration, and capable of being disposed on the connector body in a second configuration in which the volume of the outer first cavity is decreased.

In one embodiment, the fastener member, in a first configuration, is press fitted onto the connector body. Also the fastener member has an internal groove. The connector body has a detent disposed on its outer surface such that the detent is movably disposed in the internal groove in the first configuration. The detent, in the second configuration, is disposed on the inner surface of the fastener member.

The present invention is also directed to a coaxial cable connector comprising body member including a post member defining an inner first cavity, and further including a connector body coupled to said post member and defining therebetween an outer first cavity, the post member having a first opening and a second opening each communicating with said inner first cavity, and said connector body having at least one opening communicating with said outer first cavity; and fastener member defining a second cavity and having a first opening and a second opening each communicating with said second cavity, at least a portion of the fastener member being movably fastened on the connector body in a first configuration, and capable of being fastened on the connector body in a second configuration in which the volume of the outer first cavity is decreased.

The connector body and post member are each generally tubular. The connector body is fastened to a portion of the post member adjacent the second opening of the post member, and the opening of the connector body is adjacent to the first opening of the post member. In the first configuration, the first opening of the fastener member is adjacent and communicates with the opening of the outer first cavity. The area of the first opening of the fastener member is greater than the area of the opening of the connector body.

The connector body has at least one or a plurality of serrations disposed on an inner surface thereof. The fastener member is generally tubular having at least a portion thereof with an inner diameter being less than the maximum outer diameter of at least a portion of the connector body adjacent the opening of the outer first cavity. The connector body has a flange disposed on a portion of an outer surface of the connector body. The flange is positioned to contact the fastener member fastened onto the connector body in the second configuration. The connector further comprises a nut member, coupled to at least one of the body member and the post member, adjacent said second opening of said post member. The connector can further comprise a sealing member such as an O-ring disposed between the nut member and the body member. The post member has a ridge disposed in the first inner cavity adjacent the second opening of the post member.

In other embodiments, the post member, connector body and fastener member can be metallic. Alternatively, they can be formed of reinforced plastic material. In one preferred embodiment, the connector body is formed of a plastic composition.

Also the present invention is directed to a coaxial cable connector comprising first body means for coupling to a coaxial cable, and including a post means for defining an inner first cavity, and further including a connector body means coupled to the post means and defining therebetween an outer first cavity, the post means having a first opening and a second opening each communicating with the inner first cavity, and the connector body means having at least one opening communicating with the outer first cavity, the first and second openings of the post means allowing for passage of at least a portion of the coaxial cable, and the outer first cavity allowing for entry of at least another portion of the coaxial cable; and fastener means for movably engaging the first body means and defining a second cavity having a first opening and a second opening each communicating with the second cavity, the fastener means being coupled onto the connector body means in a first configuration, and the first and second openings of the fastener means allowing for passage of a portion of the coaxial cable, and capable of being coupled onto the connector body means in a second configuration for decreasing the volume of the outer first cavity.

Furthermore, the present invention relates to a connector comprising first body member including an inner member defining an inner first cavity, and further including an outer member coupled to the inner member and defining therebetween an outer first cavity, said inner member having a first opening and a second opening each communicating with said inner first cavity, and said outer member having at least one opening communicating with said outer first cavity; and second body member defining a second cavity and having a first opening and a second opening each communicating with the second cavity, at least a portion of the second body member being disposed on the outer member of the first body member in a first configuration, and capable of being disposed on the outer member in a second configuration in which the volume of the outer first cavity is decreased.

Further still, an embodiment of the present invention is directed to a connector for coupling an end of a coaxial cable to an interface port, the coaxial cable having a center conductor surrounded by a dielectric, the dielectric being surrounded by a protective outer jacket, said connector comprising a connector body for receiving the coaxial cable, wherein the connector body includes a first end, the first end including an opening defined by an exterior casing and an integral interior post, the post adapted to be inserted into an end of the coaxial cable around the dielectric and under the protective outer jacket thereof.

Additionally an embodiment of the present invention is directed to a connector for coupling an end of a coaxial cable to an interface port, the coaxial cable having a center conductor surrounded by a dielectric, the dielectric being surrounded by a protective outer jacket, said connector comprising a fastener member, wherein the fastener member causes the exterior casing of the connector body to be deformed inwardly toward the interior post of the connector body and against the protective outer jacket of the coaxial cable as received and as the fastener member is advanced over the connector body.

Moreover an embodiment of the present invention is directed to a connector for coupling an end of a coaxial cable to an interface port, the coaxial cable having a center conductor surrounded by a dielectric, the dielectric being surrounded by a protective outer jacket, said connector comprising a connector body for receiving the coaxial cable, wherein the connector body includes a first end and a second end, the first end including an opening partially defined by an unbroken surface extending between an exterior casing and an interior post, the post adapted to be inserted into an end of the coaxial cable around the dielectric and under the protective outer jacket thereof, the second end having a ringed flange.

Still further, an embodiment of the present invention is directed to a connector for coupling an end of a coaxial cable to an interface port, the coaxial cable having a center conductor surrounded by a dielectric, the dielectric being surrounded by a protective outer jacket, said connector comprising a fastener member having a first end and opposing second end with a central passageway defined between the fastener member first end and the fastener member second end for allowing a portion of the coaxial cable to pass there through, the fastener member secured to the connector body prior to installation over the end of the coaxial cable in a preinstalled first configuration, the central passageway being dimensioned to compress the connector body radially inwardly when the fastener member is slidingly moved from the first preinstalled configuration toward the second end of the connector body, wherein the fastener member causes the exterior casing of the connector body to be deformed inwardly toward the interior post of the connector body and against the protective outer jacket of the coaxial cable as received and as the fastener member is advanced over the connector body.

In addition, the present invention is directed to a method of positioning a connector on a coaxial cable, the coaxial cable comprising a center conductor, an insulator core, an outer conductor, and a sheath, comprises preparing an end of the coaxial cable by separating the center conductor and insulator core from the outer conductor and sheath; providing a first body member including a post member defining an inner first cavity, and further including a connector body coupled to the post member and defining an outer first cavity therebetween, the post member having a first opening and a second opening each communicating with the inner first cavity, and the connector body having at least one opening communicating with the outer first cavity; providing a second body member defining a second cavity having a first opening and a second opening each communicating with the second cavity; movably fastening the second body member onto at least a portion of an outer surface of the connector body in a first configuration; inserting the prepared coaxial cable end through the second opening of the second body member and extending the center conductor of the prepared coaxial cable end out of second opening of post member; and moving second body member on connector body to a second configuration so as to decrease the volume of outer first cavity such that the first body member engages the outer conductor and sheath of the coaxial cable.

The step of moving the second body member on the connector body to its second configuration includes forcibly sliding the second body member along the connector body. The step of inserting the prepared end of the coaxial cable further includes advancing the coaxial cable such that the insulator core engages a ridge disposed within post member.

Moreover, the present invention is directed to a coaxial connector for coupling a coaxial cable to a device, the coaxial cable including a center conductor, an insulating core, an outer conductor and a sheath, comprising post member defining an inner first cavity, the post member having a first opening and a second opening each communicating with the inner first cavity; connector body coupled to the post member and defining therebetween an outer first cavity having at least one opening communicating with the outer first cavity; fastener member defining a second cavity and being coupled to the connector body for sliding engagement on the outer surface of the connector body, from a first configuration wherein the fastener member is fastened onto the connector body prior to coupling to the coaxial cable, to a second configuration after the coaxial cable is inserted into the connector and wherein the fastener member coacts with the connector body so that the connector sealingly grips the coaxial cable.

In an embodiment, the fastener member includes an internal groove, and the connector body includes a detent, whereby the internal groove and the detent cooperate such that the fastener member is movably fastened to the connector body in its first configuration. In an alternative embodiment, the fastener member includes a detent, and the connector body includes a notch, whereby the detent and the notch cooperate such that the fastener member is securely fastened to the connector body in its first configuration. In one embodiment, the connector body includes a second notch, whereby the detent and the second notch cooperate such that the fastener member is securely fastened to the connector body in its second configuration. The fastener member has a first inner bore dimensioned so as to deform the connector body in its first configuration, and wherein the fastener member has a second inner bore dimensioned so as to further deform the connector body in its second configuration. The connector body includes a flange positioned to engage the fastener member in the second configuration. The connector further includes a nut member coupled to the post member. The nut member can include a flange positioned to engage the fastener member in the second configuration. The post member includes a protrusion disposed to securely couple with the connector body member. The connector body includes a plurality of annular serrations disposed on an inner surface thereof. The outer surface of the connector body has a plurality of corrugations disposed opposite the plurality of annular serrations.

In addition, an embodiment of the present invention is directed to a method of improving RF shieiding and reducing noise ingress into a coaxial cable connector having a connector body and a post, said method comprising providing the post integral with the connector body, whereby the integration results in simultaneously providing for improved RF shielding and reduction in noise ingress into the connector.

Moreover, an embodiment of the present invention is directed to a method of improving RF shielding and reducing noise ingress into a coaxial cable connector, said method comprising a step of providing a connector. The provided connector includes a unitary connector body for receiving the coaxial cable, wherein the unitary connector body includes an exterior casing and an interior post. Furthermore the provided connector includes a fastener member, wherein the fastener member causes the opening of the connector body to be decreased as the fastener member is advanced over the connector body.

Further, an embodiment of the present invention is directed to method of improving RF shielding and reducing noise ingress into a coaxial cable connector, said method comprising a step of inserting a coaxial cable end through the fastener member and onto the connector body, wherein the connector body facilitates improved RF shielding and reduction of noise ingress into the connector.

Further still, an embodiment of the present invention is directed to a method of improving RF shielding and reducing noise ingress into a coaxial cable connector, said method comprising a step of advancing the fastener member from a first preinstalled configuration to a second configuration such that a continuous seal and secure grip is formed between the connector and the coaxial cable.

### BRIEF DESCRIPTION OF THE DRAWINGS

The present invention is described in detail below with reference to the drawings in which:

FIG. 1 is a longitudinal cross-sectional view of a preferred embodiment of a connector according to the present invention shown adjacent to the prepared end of a coaxial cable, and wherein the fastener member is in a first configuration;

FIG. 2 is a longitudinal cross-sectional view of the post member of the connector of FIG. 1;

FIG. 3 is a longitudinal cross-sectional view of the connector body of the connector of FIG. 1;

FIG. 4 is a longitudinal cross-sectional view of the fastener member of the connector of FIG. 1;

FIG. 5 is a longitudinal cross-sectional view of the connector of FIG. 1 with the fastener member in a second configuration;

FIG. 6 is a longitudinal cross-sectional view of another embodiment of a connector according to the present invention wherein the post member has an enlarged portion, and wherein the fastener member is in a first configuration;

FIG. 7 is a longitudinal sectional view of yet another embodiment of a connector according to the present invention wherein the fastener member is in a first configuration;

FIG. 8 is a longitudinal cross-sectional view of the post member of the connector of FIG. 7;

FIG. 9 is a longitudinal cross-sectional view of the connector body of the connector of FIG. 7;

FIG. 10 is a longitudinal cross-sectional view of the fastener member of the connector of FIG. 7;

FIG. 11 is a longitudinal cross-sectional view of the nut member of the connector of FIG. 7;

FIG. 12 is a longitudinal cross-sectional view of the connector of FIG. 7 with the fastener member in a second configuration;

FIG. 13 is a perspective sectional view of the connector of FIG. 7 with the fastener member in a second configuration;

FIG. 14 is a longitudinal sectional view of still another embodiment of a connector according to the present invention wherein the fastener member is in a first configuration;

FIG. 15 is a longitudinal cross-sectional view of the post member of the connector of FIG. 14;

FIG. 16 is a longitudinal cross-sectional view of the connector body of the connector of FIG. 14;

FIG. 17 is a longitudinal cross-sectional view of the fastener member of the connector of FIG. 14;

FIG. 18 is a longitudinal cross-sectional view of the nut member of the connector of FIG. 14;

FIG. 19 is a longitudinal cross-sectional view of the connector of FIG. 14 with the fastener member in a second configuration;

FIG. 20 is a perspective cross-sectional view of the connector of FIG. 14 with the fastener member in a second configuration;

FIG. 21 is a perspective view of the connector of FIG. 7 with the fastener member in a second configuration;

FIG. 22 is a perspective view of the connector of FIG. 14 with the fastener member in a second configuration;

FIG. 23 is an exploded cut-away perspective view of still another embodiment of a connector according to the present invention;

FIG. 24 is a cut-away perspective view of a fastener member embodiment corresponding to the connector of FIG. 23;

FIG. 25 is a cut-away perspective view of a connector body embodiment corresponding to the connector of FIG. 23; and,

FIG. 26 is a cut-away perspective view of the connector of FIG. 23 wherein the connector is in a first preinstalled configuration.

FIG. 27 is a cut-away perspective view of one embodiment of a connector body, in accordance with the present invention.

### DETAILED DESCRIPTION OF PREFERRED EMBODIMENTS

In the description which follows, any reference to either direction or orientation is intended primarily and solely for purposes of illustration and is not intended in any way as a limitation to the scope of the present invention. Also, the particular embodiments described herein, although being preferred, are not to be considered as limiting of the present invention.

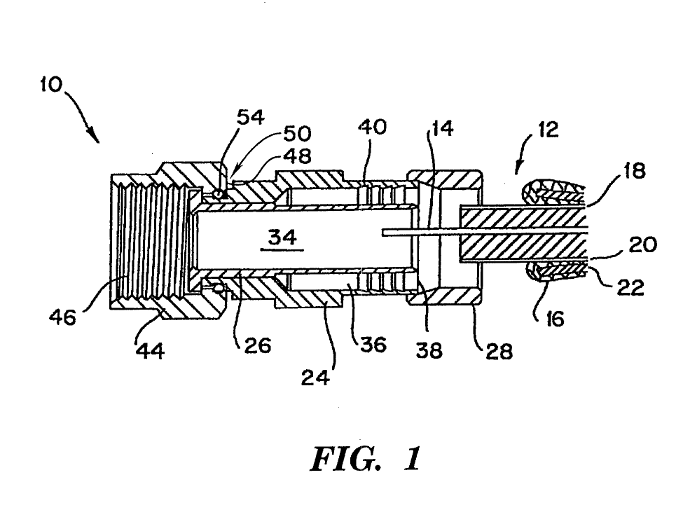

Referring to FIG. 1, a connector 10 in accordance with one embodiment of the present invention is shown adjacent to the prepared end of a cable 12. In the example illustrated, cable 12 can be a known coaxial type having an electrical center conductor 14 surrounded by and spaced radially inwardly from a braid conductor 16 by a foil 18 and an insulator core 20. A dielectric covering or sheathing jacket 22 surrounds the braid 16 and comprises the outermost layer of the cable. Although an exemplary coaxial cable has been described, the connector 10 of the present invention can also be used with coaxial cables having configurations different from that disclosed above.

An end of the cable is prepared, as shown in FIG. 1, to receive the connector 10 by selectively removing various layers to progressively expose an end of the center conductor 14 and an end of the insulator core 20 and foil 18 as illustrated. An end portion of the braid conductor 16 is folded over sheathing jacket 22.

Referring to one embodiment of the present invention shown in FIGS. 1-4, the connector 10 is configured and dimensioned to accommodate receiving the prepared end of a coaxial cable. The connector 10 has a first body member that includes connector body 24 and post member 26. The connector 10 also has a second body member which as shown in FIGS. 1-4 is fastener member 28. The post 26 is a tubular member having a first opening 30 and a second opening 32. The post 26 defines a first inner cavity 34. The inner surface of connector body 24 is radially spaced about the post 26 to define a first outer cavity 36 accessible via opening 38 at one end of the connector body 24. The first outer cavity 36 is closed at the other end of connector body 24 together with post member 26.

The connector body 24 and the post member 26 are separate components wherein the connector body 24 is press fitted onto the outer surface of the post member 26. In this embodiment, the connector body 24 is formed of brass or a copper alloy and the post member is formed of brass. In another embodiment, the connector body 24 and post member 26 can be formed integrally as a single piece. Also, the connector body 24 can be formed of a plastic composition.

Advantageously, the inner surface of the connector body 24 has annular serrations 40 disposed opposite the post member 26. Similar serrations are illustrated and described in U.S. Pat. No. 5,073,129 (Szegda) which is incorporated herein in its entirety. As discussed in more detail below, the post member 26 and annular serrations 40 of the connector body 24 provide for a continuous environmental seal and grip on the braid 16 and sheathing jacket 22 of the cable when the fastener member 28 is in its second configuration.

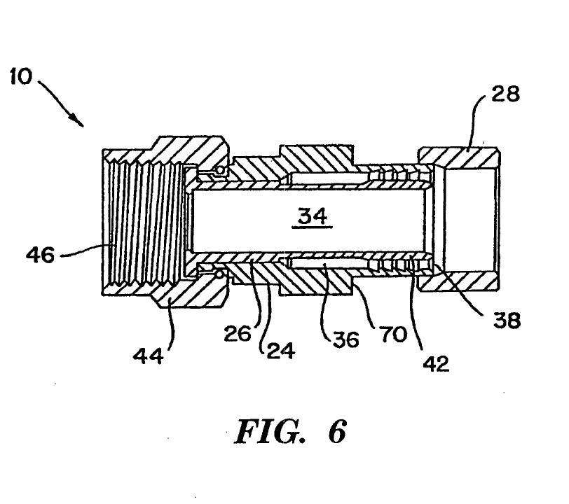

Referring to FIG. 6, in still another embodiment, the outer surface of the post member 26 can be configured with a radially enlarged portion 42 within the first outer cavity 36 at a location proximate to opening 38. Similar to the embodiment of FIG. 1, the radially enlarged portion 42 of the post member and annular serrations 40 of the connector body cooperate to provide for a continuous environmental seal and grip on the braid and sheathing jacket of the cable when the fastener member 28 is in its second configuration.

As illustrated in FIGS. 1, 3, and 5, the nut member 44 is internally threaded as at 46 and is provided with a shoulder 48 seated in groove 50 formed by the outer surface of the base of post 26 and groove 52 of the connector body 24. The nut 44 and post 26 are rotatable. An O-ring seal 54 can be seated in groove 52 of connector body 24 to serve as a moisture barrier.

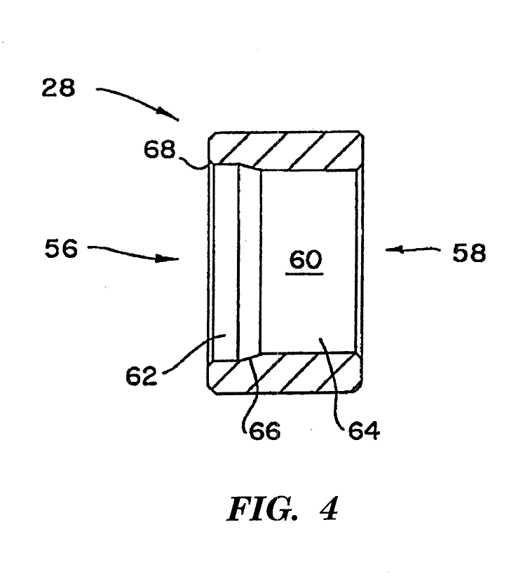

Fastener member 28 is shown in FIGS. 1 and 4 as being of a tubular configuration. The fastener member 28 is preferably formed of steel with an electroless nickel/teflon finish, and has a first opening 56 and a second opening 58 which define a second cavity 60. The fastener member 28 includes a first inner bore 62 having a first diameter, and a second inner bore 64 having a second diameter which is less than the diameter of the first bore. The first inner bore 62 has a first diameter which is a constant diameter internal bore or a non-tapered internal bore. A ramped surface 66 is provided between the first 62 and second 64 bores. Also, at first inlet opening 56, a slight flare 68 extending from the first bore to inlet opening 56 is preferably provided to allow the fastener member 28 to be fastened onto the connector body 24. Although the fastener member 28 can be coupled to the connector body 24 such that the fastener member 28 can be removed by hand, in the embodiments illustrated in FIGS. 1 and 4, the fastener member 28 is dimensioned and configured relative to the dimensions of the connector body 24 so that the fastener member 28 is securely attached to the connector body 24. Such attachment can be obtained by a press fit assembly. As described herein, the fastener member 28 is movably coupled to the connector body 24 so as to be capable of being moved on the connector body 24 from a first preassembled configuration to a second assembled configuration. The fastener member or compression ring 28 is not attached to a threaded member, but is axially slidably engaged with the connector body 24. Both the first inner bore 62 and the second inner bore 64 have diameters which are less than an outer diameter d of the portion of the connector body that accepts the fastener member 28.

In a pre-installed first configuration as illustrated in FIG. 1, the fastener member 28 is fastened onto the connector body 24 such that the first bore 62 is securely attached to the connector body 24, and such that the connector body 24 is gripped to affect a corresponding decrease in the volume of the first outer cavity 36. Thus, the connector body 24 is pushed radially inwardly towards the outer surface of the post 26. In this manner, the fastener member 28, in its pre-installed first configuration, is securely fastened to the connector body 24 and is thus in an assembled state during storage, handling, and installation on a cable end. This eliminates any danger of the fastener member 28 being dropped or otherwise mishandled during handling and installation as is prevalent in known designs. For example, during a high installation, such as atop a building or on a telephone pole, the fastener member may slip down the cable while the installer is in the process of installing the connector. The Installer would need to halt the installation and retrieve the fastener member 28 from its slipped position down the cable in order to resume and then complete the installation.

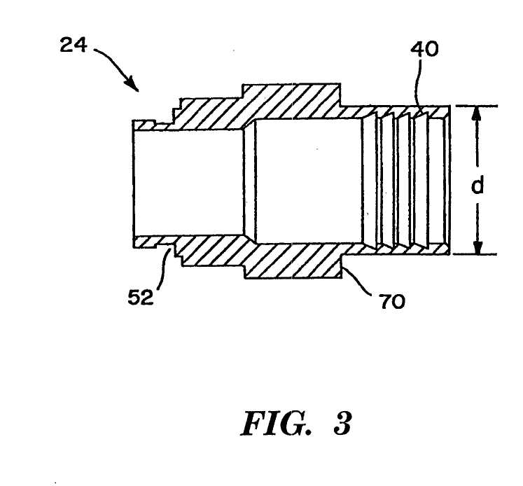

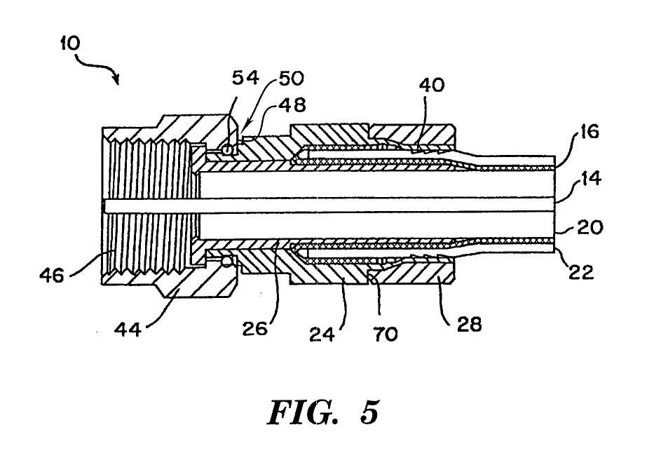

The second configuration shown in FIG. 5 is achieved after the fastener member 28 is axially moved along the connector body 24 to a second location on the connector body 24 such that the second inner bore 64 of the fastener member 28 engages the outer surface of the connector body 24. As shown in FIGS. 3 and 5, flange 70 on the connector body 24 is provided to engage the fastener member 28 at its second configuration. In this embodiment, flange 70 may be a tubular ring or a portion thereof as shown. Alternatively, however, flange 70 can be formed of one or more protrusions from the outer surface of the connector body 24 at one or more locations.

A method of positioning the connector on a coaxial cable is now described with reference to FIGS. 1 and 5. The end of a coaxial cable is prepared by exposing a central core portion including the center conductor 14, insulator core 20, and foil 18. The outer braid conductor 16 is folded over the end of the outer sheath jacket 22. The prepared end of the coaxial cable can be inserted through the second opening of fastener member 28 such that the central core portion including the center conductor 14, insulator core 20, and foil 18 is inserted into the first inner cavity 34 of post member 26. Also, the outer portion of the cable including outer braid conductor 16 folded over the end of the outer sheath jacket 22 is received into the first outer cavity 36 through opening 38.

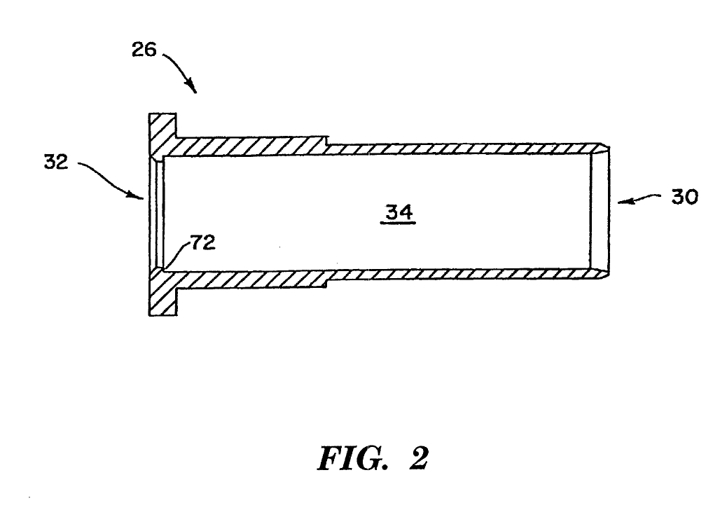

Advantageously, as illustrated in FIG. 2, an internal ridge 72 is provided within the first inner cavity 34 of the post member adjacent second opening 32. The ridge 72 is positioned such that the exposed end of the center conductor 14 protrudes beyond the second opening 32 of the post member 26, while the insulator core portion and foil of the cable is prevented from being displaced through second opening 32 of the post member 26.

Once the insulator core portion of the cable is positioned to abut ridge 72 of the post member 26, the fastener member 28 is then advanced or moved axially from its pre-installed first configuration to its second configuration by a standard tool. As discussed above, in an embodiment, the fastener member 28 engages flange 70 of the connector body 24 in its second configuration.

Since the diameter of the second inner bore 64 of fastener member 28 is smaller than the diameter d, shown in FIG. 3, of the portion of the connector body 24 accepting the fastener member 28, the connector body is concentrically gripped so that the volume of the outer first cavity is further decreased. That is, the connector body 24 is further displaced or moved and compressed radially inwardly to decrease the volume of the first outer cavity 36 or first central bore when the fastener member 28 is slidingly moved from the first preinstalled configuration toward the second end of the connector body 24. As a result, the outer portion of the cable is firmly gripped or clamped between the outer surface of post member 26 and connector body 24. In this manner, in an embodiment, the post member 26 cooperates with the annular serrations 40 of the connector body to provide a generally continuous, 360° seal and grip on the outer portion of the cable. In another embodiment as shown in FIG. 6, the flared portion 42 of post member 26 cooperates with the annular serrations 40 of the connector body 24 in a similar manner. Advantageously, both of these constructions eliminate the need for an O-ring or other seal between the connector body 24 and the fastener member 28, and can accommodate a wide range of cable types and sizes. Thus the need for connectors of various sizes can be avoided with a universal connector of the present invention.

Once the fastener member 28 is in its second configuration, nut 44 may then be employed to attach the connector to a system component—typically a threaded port or the like.

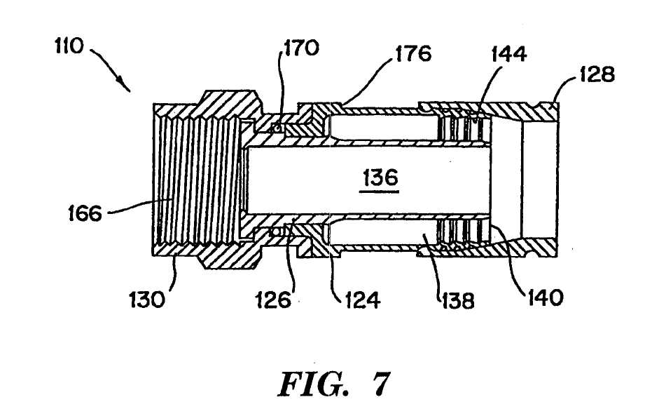

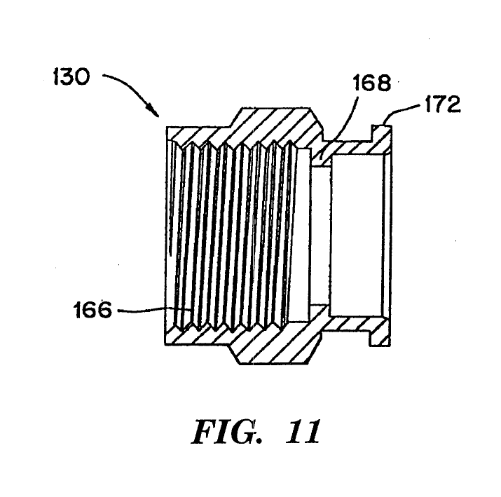

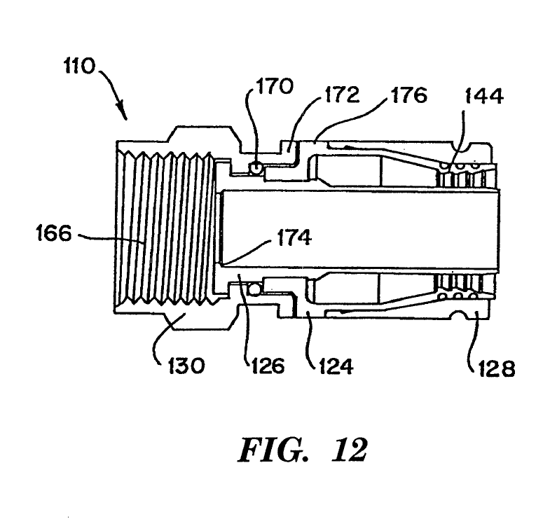

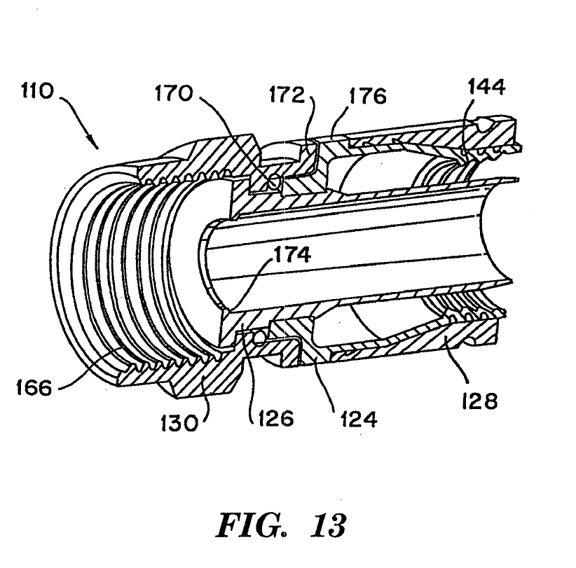

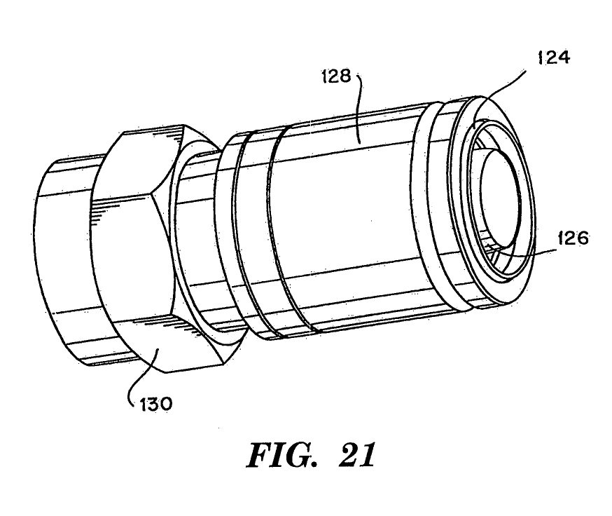

Referring to FIGS. 7-13 and FIG. 21 which illustrate yet another embodiment, the connector 110 includes a connector body 124, a post member 126, a fastener member 128, and a nut member 130. FIG. 7 shows the connector with the fastener member 128 in its first configuration, while FIGS. 12-13 and FIG. 21 show the connector 110 with the fastener member 128 in its second configuration.

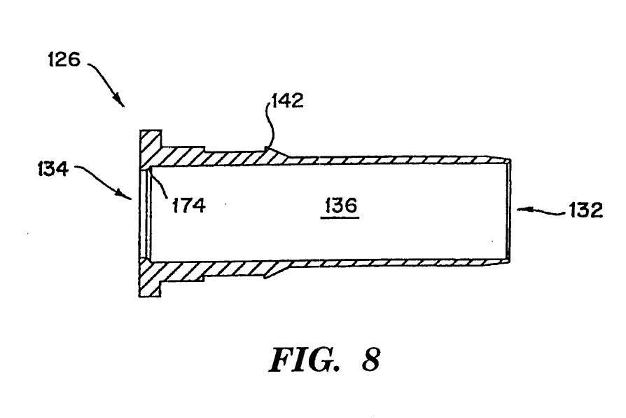

Similar to the connector of FIGS. 1-6, post member 126, which is formed of brass, includes an inner tubular member having a first opening 132 and a second opening 134. The post member 126 defines a first inner cavity 136. The inner surface of connector body 124 is radially spaced from post member 126 to define a first outer cavity 138 accessible via opening 140. The first outer cavity 138 is closed at its far end by post member 126 and connector body 124. As illustrated in FIGS. 7-8, post member 126 can also include a protrusion 142 on its outer annular surface for engaging the connector body 124, which is otherwise attached to the post member by an interference fit, to insure a secured attachment with the connector body 124.

Like the connector body of the connector of FIGS. 1-6, the inner surface of connector body 124 has annular serrations 144 disposed opposite the post member. The post member 126 and annular serrations 144 of the connector body 124 provide for a generally continuous environmental seal and grip on the braid 16 and sheathing jacket 22 of the cable when the fastener member is in its second configuration. In an embodiment, the connector body is preferably comprised of a plastic such as DELRIN™.

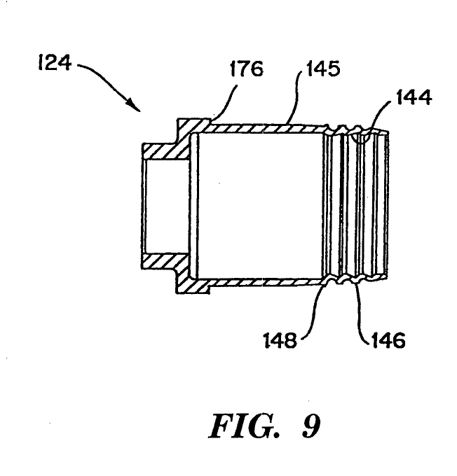

As shown in FIG. 9, the connector body wall tapers as at 145 to facilitate the generally radial movement of the connector body 124 when the fastener member 128 is moved into its second configuration. The connector body 124 can also include a corrugated surface portion 146 opposite annular serrations 144. This corrugated surface portion is believed to reduce the driving force needed to move or slide fastener member 128 along connector body 124. Also, the connector body 124 can include a detent 148 disposed on its outer surface to cooperate with an internal groove 150 of the fastener member to insure that the fastener member 128 is fastened to the connector body 124 in its first configuration. The detent 148 can be a ring like protrusion or can be formed of discrete protrusions about the connector body.

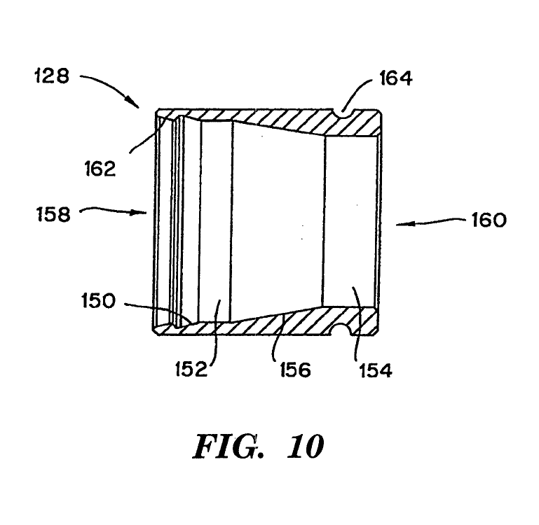

Referring to FIGS. 7 and 10, fastener member 128, which is formed of brass, includes a first inner bore 152 having a first diameter and a second inner bore 154 having a second diameter which is less than the diameter of the first bore. A ramped surface 156 is provided between the first and second bores. Fastener member 128 has a first opening 158 adjacent the first inner bore and a second opening 160 adjacent the second inner bore. A flared inner portion or tapered portion 162 is provided at the first opening to facilitate sliding of the fastener member along the connector body.

Fastener member 128 also includes internal groove 150 adjacent first opening 158. As discussed above, this internal groove cooperates with detent 148 of the connector body to insure that the fastener member is securely fastened to the connector body in its first configuration as shown in FIG. 7. Fastener member may also include a notch 164 on its outer annular surface for assembly line purposes. This notch is not critical to the operation of the connector.

The first inner bore 152 may be dimensioned so as to radially compress the connector body inwardly when the fastener member is in its first configuration. Alternatively, the first inner bore 152 may be dimensioned to simply provide a press fit between the fastener member and the connector body when the fastener member is in its first configuration. In any event, in both of these constructions, the detent 148 of the connector body and the internal groove 150 of the fastener member cooperate to insure that the fastener member is securely fastened to the connector body in its first configuration.

The second inner bore 154 is dimensioned to compress the connector body radially inwardly when the fastener member is in its second configuration. Of course, where the first inner bore is dimensioned to radially compress the connector body member radially inwardly when the fastener member is in its first configuration, the second inner bore would further compress the connector body radially inwardly when the fastener member is in its second configuration.

As illustrated by FIGS. 7, 11, 12, and 13, nut member 130 is internally threaded as at 166 and is provided with a first shoulder 168 seated in a groove formed by the base of post member 126 and connector body 124. An O-ring seal 170 may be seated between the post member, the connector body, and the nut member to serve as a moisture barrier. The nut member may also include a second shoulder 172. Second shoulder 172 reinforces the connector body and may be used as a surface for the tool utilized to forcibly slide the fastener member along the connector body.

A method of positioning the connector of FIGS. 7-13 on a coaxial cable is now described. The end of a coaxial cable is prepared as discussed above with respect to the end connector of FIGS. 1-6. Then, the prepared end of the coaxial cable is inserted through the second opening of the fastener member such that the central core portion comprising the center conductor 14, insulator core 20, and foil 18 is inserted into the first inner cavity 136 of post member 126 just as discussed above with respect to the connector of FIGS. 1-6. Also, the outer portion of the cable comprising outer braid conductor 16 folded over the end of the outer sheath jacket 22 is received into the first outer cavity 138 through opening 140.

The insulator core and foil of the cable is then axially displaced within the post member to ridge 174. The ridge is positioned such that the exposed end of the center conductor 14 protrudes beyond second opening 134 of the post member, while the insulator core portion 20 and foil 18 of the cable is prevented from being displaced through second opening 134 of the post member.

Once the insulator core and foil of the cable is positioned to abut ridge 174 of the post member, the fastener member is then advanced or moved axially from its pre-installed first configuration to its second configuration by a standard tool. In this second configuration, the fastener member engages flange 176 of the connector body which acts as a positive stop.

As discussed above, the second inner bore 154 of the fastener member is dimensioned to concentrically compress the connector body so that the volume of the outer first cavity 138 is decreased. That is, the connector body is deformed radially inwardly. As a result, the outer portion of the cable is firmly clamped between the outer surface of post member 126 and connector body 124. In this manner, in the preferred embodiment, the post member cooperates with the annular serrations 144 of the connector body to provide a generally continuous, 360° seal and grip on the outer portion of the cable. Advantageously, like the connector of FIGS. 1-6, this construction eliminates the need for an O-ring or other seal between the connector body and the fastener member, and can accommodate a wide range of cable types and sizes.

Once the fastener member is in its second configuration, nut 130 may then be employed to attach the connector to a system component—typically a threaded port or the like.

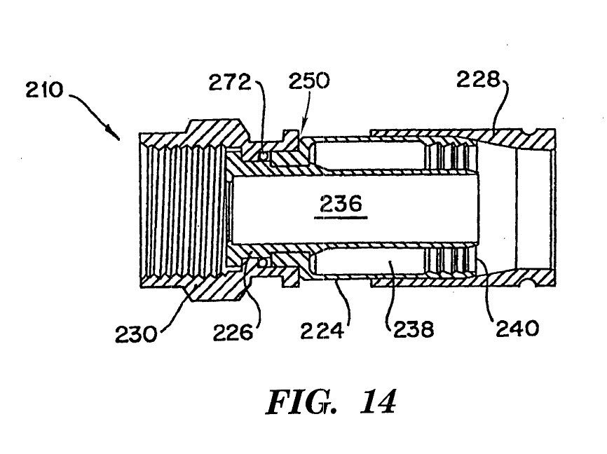

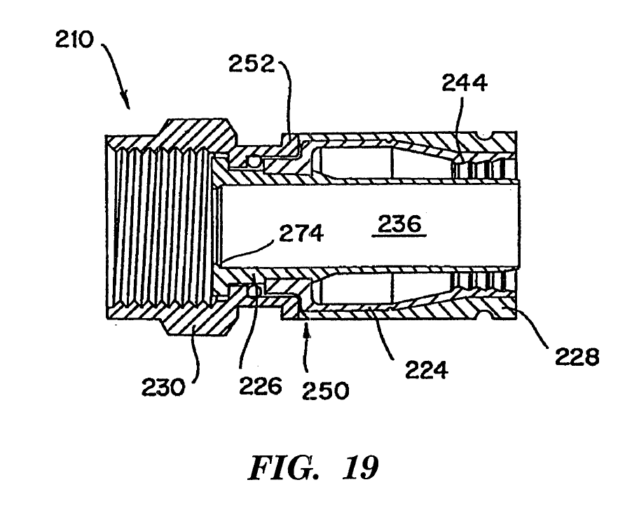

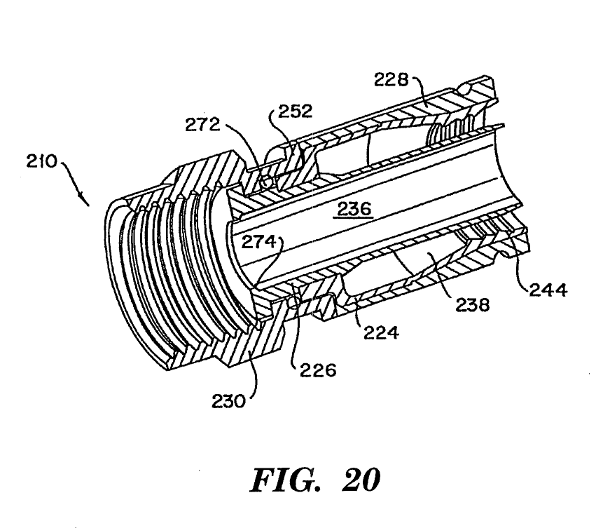

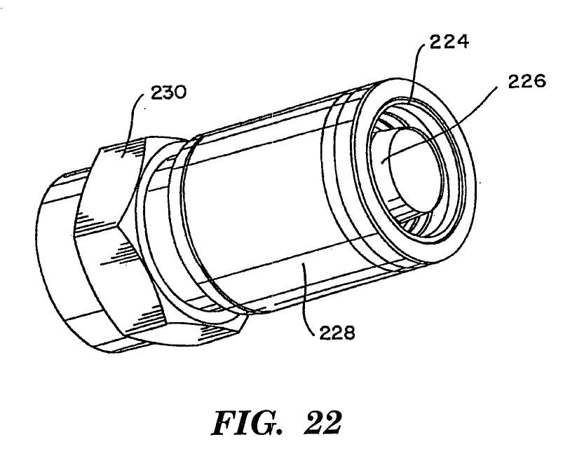

Referring to FIGS. 14-20 and FIG. 22, which illustrate still another alternative embodiment, connector 210 includes a connector body 224, a post member 226, a fastener member 228, and a nut member 230. FIG. 14 shows the connector with the fastener member in its first configuration, while FIGS. 19-20 and FIG. 22 show the connector with the fastener member in its second configuration.

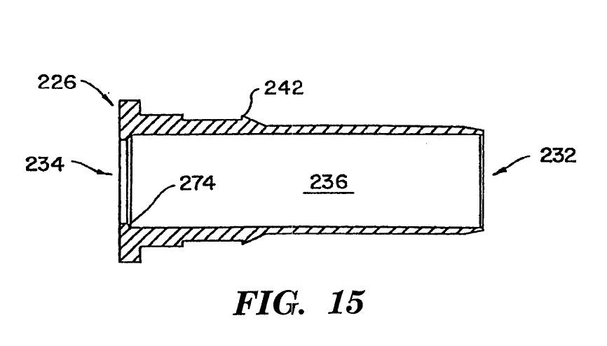

Similar to the connector of FIGS. 1-6, post member 226, which may be formed of brass, includes an inner tubular member having a first opening 232 and a second opening 234. The post member defines a first inner cavity 236. The inner surface of connector body cooperates in a radially spaced relationship with the post member to define a first outer cavity 238 accessible via opening 240. The first outer cavity 238 is closed at its far end by post member 226 and connector body 224. As illustrated in FIGS. 14 and 15, post member may also include a protrusion 242 on its outer surface for engaging the connector body, which is otherwise attached to the post member by an interference fit, to insure a secured coupling with the connector body.

Like the connector body of the end connector of FIGS. 1-6, the inner surface of the connector body may include annular serrations 244 disposed opposite the post member. The post member and annular serrations 244 of the connector body provide for a generally continuous environmental seal and grip on the braid 16 and sheathing jacket 22 of the cable when the fastener member is in its second configuration. In such an embodiment, the connector body may be comprised of a plastic such as DELRIN™.

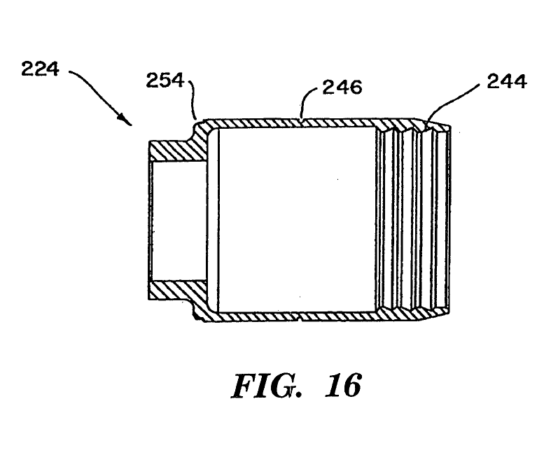

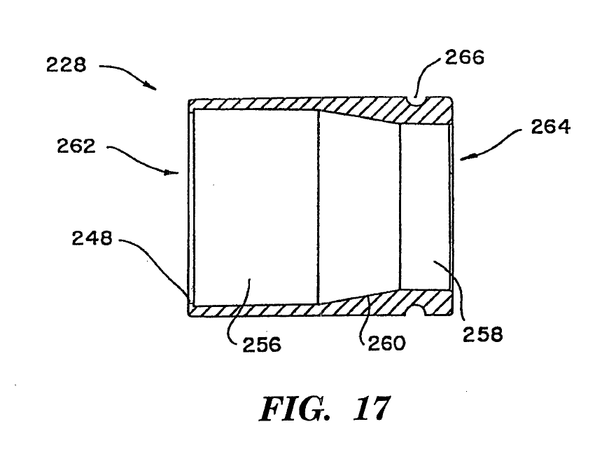

Referring to FIGS. 16 and 17, connector body 224 also may include a first notch 246 disposed on its outer surface for accepting a detent 248 of fastener member 228 to insure that the fastener member is securely fastened to the connector body in its first configuration. As shown in FIGS. 14 and 16, the outer surface of the connector body 224 includes a slight taper 245 at its first end to facilitate insertion of the connector body 224 into the fastener member 228. Moreover, as illustrated in FIGS. 14, 16, and 18, a groove 250 may be formed between a second shoulder 252 of the nut member and a second notch 254 on connector body 224 such that the groove 250 accepts detent 248 of the fastener member in its second configuration. However, this groove may be eliminated such that fastener member simply abuts the positive stop provided by second shoulder 252 of the nut member when the fastener member is in its second configuration.

Referring to FIG. 17, similar to the fastener members shown in FIGS. 4 and 10, fastener member 228 is formed of brass and includes a first inner bore 256 having a first diameter and a second inner bore 258 having a second diameter which is less than the diameter of the first bore. A ramped surface 260 is provided between the first and second bores. Also, fastener member has a first opening 262 adjacent the first inner bore and a second opening 264 adjacent the second inner bore.

Fastener member also includes detent 248 extending inwardly at its first opening 262. As discussed above, this detent cooperates with notch 246 of connector body to insure that the fastener member is securely fastened to the connector body in its first configuration as shown in FIG. 14. Fastener member may also include a notch 266 on its outer annular surface for assembly line purposes. This notch is not critical to the operation of the connector.

The first inner bore 256 may be dimensioned so as to radially compress the connector body inwardly when the fastener member is in its first configuration. Alternatively, the first inner bore 256 may be dimensioned to simply provide a press fit between the fastener member and the connector body when the fastener member is in its first configuration. In any event, in both of these constructions, detent 248 of the fastener member cooperates with notch 246 of the connector body to insure that the fastener member is securely fastened to the connector body in its first configuration.

The second inner bore 258 of fastener member 228 is dimensioned to compress the connector body radially inwardly when the fastener member is in its second configuration. Of course, where the first inner bore 256 is dimensioned to radially compress the connector body member radially inwardly when the fastener member is in its first configuration, the second inner bore 258 would further compress the connector body radially inwardly when the fastener member is in its second configuration.

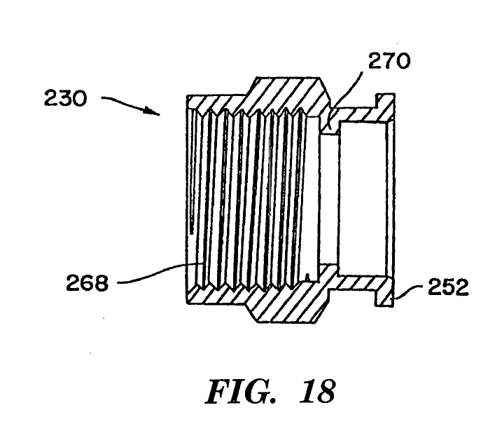

As illustrated by FIGS. 14 and 18, nut member 230 is internally threaded as at 268 and is provided with a first shoulder 270 seated in a groove formed by the base of post member 226 and connector body 224. An O-ring seal 272 may be seated between the post member, the connector body, and the nut member to serve as a moisture barrier. The nut member also includes second shoulder 252. Second shoulder 252 reinforces the connector body and may be used as a surface for the tool utilized to forcibly slide the fastener member along the connector body.

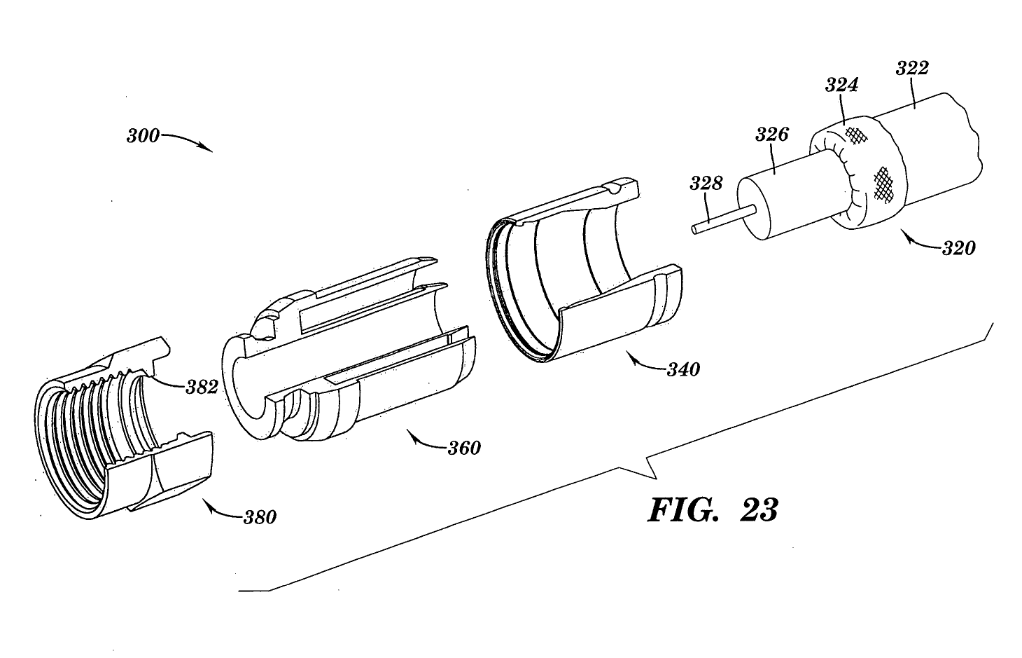

Referring to the drawings, FIG. 23 depicts an exploded cut-away perspective view of still another embodiment of a connector 300 according to the present invention. The connector 300 comprises a prepared coaxial cable 320 having a protective outer jacket 322 removed and a braided shield 324 drawn back to expose an interior dielectric 326. The dielectric 326 is stripped to expose a center conductor 328. It should be recognized that the radial thickness of the coaxial cable 320, protective outer jacket 322, braided shield 324, interior dielectric 326 and/or center conductor 328 may vary based upon generally recognized parameters corresponding to coaxial cable communication standards and/or equipment. The radial geometry of the connector 300 may accordingly correspond to the radial dimensions of coaxial cable 320. Additionally, the connector 300 may further comprise a fastener member 340, a connector body 360 and a threaded nut 380 having an internal lip 382.

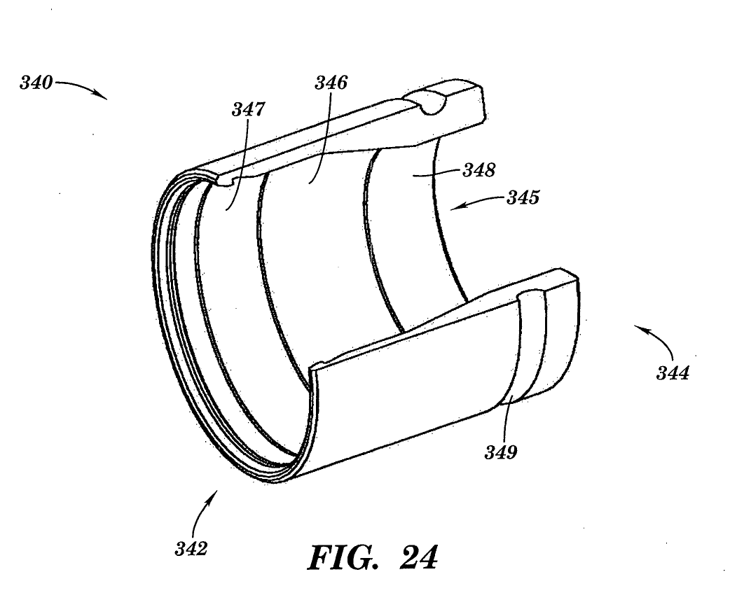

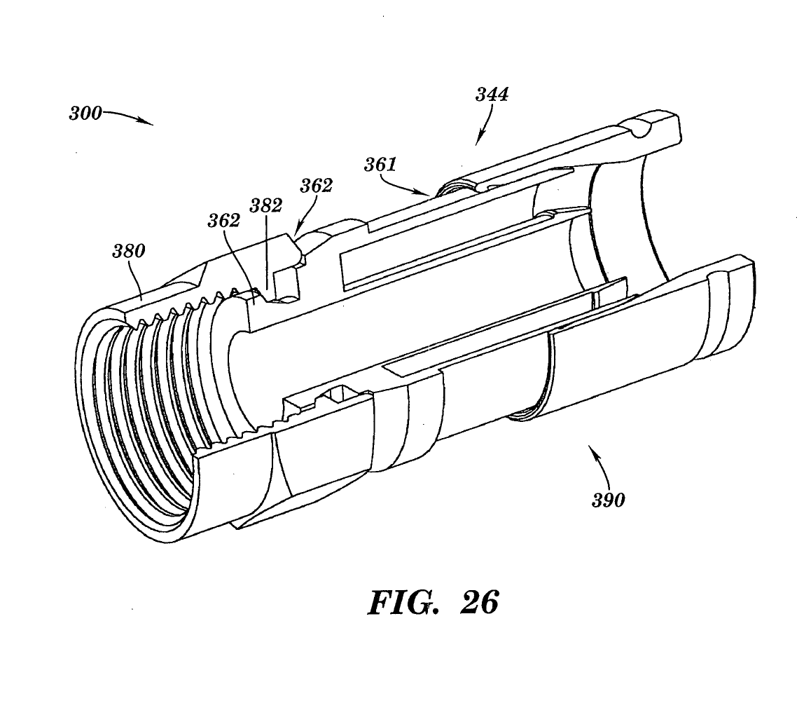

Referring to FIG. 24, an embodiment of a fastener member 340 in accordance with the present invention is shown. The fastener member 340 may have a first end 342 and opposing second end 344. Moreover, the fastener member 340 may comprise a central passageway 345 defined between the fastener member 340 first end 342 and fastener member 340 second end 344 and extending axially through the fastener member 340 thereby allowing a portion of the coaxial cable 320 (see FIG. 23) to pass therethrough. The central passageway 345 may comprise a ramped surface 346 which may be positioned between a first opening or inner bore 347 having a first diameter positioned proximate with the first end 342 of the fastener member 340 and a second opening or inner bore 348 having a second diameter positioned proximate with the second end 344 of the fastener member 340. Additionally, the fastener member 340 may comprise an exterior surface feature 349 positioned proximate with the second end 344 of the fastener member 340. The surface feature 349 may facilitate gripping of the fastener member 340 during operation of the connector 300 (see FIG. 26). Although the surface feature is shown as a hemispherical detent, it may have various shapes and sizes such as a ridge, notch, protrusion, knurling, or other friction or gripping type arrangements.

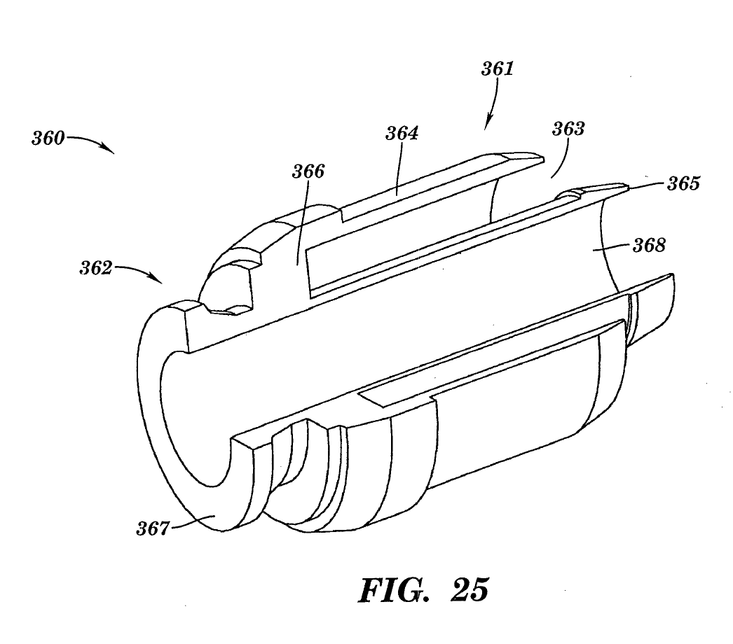

Referring now to FIG. 25, a cut-away perspective view of a connector body 360 of a connector 300 according to one embodiment of the present invention is illustrated. The connector body 360 may comprise a first end 361 and axially opposing second end 362. Moreover, the connector body 360 may comprise an opening 363 such as a molded circular opening or ringed bore extending within an exterior shell or casing 364 and about an interior post 365. The interior post 365 may be adapted such that it may be inserted into an end of a coaxial cable 320 around the dielectric 326 and under the protective outer jacket 322 and corresponding braided shield 324 (see FIG. 23). Additionally, the interior post 365 is formed with a central opening 368 such as an axial bore for allowing portions of the coaxial cable 320 to be axially inserted through the interior post 365. For example, during positioning of the coaxial cable 320 on the connector 300, the central conductor 328 and/or dielectric 326 may pass through the central opening or axial bore 386 of the interior post 365 of the first end 361 of the connector body 360 and out the second end 362 of the connector body 360. Furthermore, the connector body 360 may comprise an interior wall 366. The interior wall 366 is formed integrally with exterior shell or casing 364 such that it facilitates a single mold, single machined piece, unitary, or single-body structured connector body 360 wherein the interior wall 366 defines and allows for an unbroken surface between the exterior shell or casing 364 and the interior post 365 of the connector body 360.

Several advantages pertain to the integral nature of the incorporated, built in, molded, or unitarily machined structuring of the interior wall 366 connecting the exterior shell or casing 364 and the interior post 365 of connector body 360. For example, the integral structuring prevents moisture or other sealing problems between the interior post 365 and the exterior shell or casing 364. Also, it reduces the number of parts required for assembly and formation during manufacture. For instance, a sealing O-ring between the threaded nut 380 and connector body 360 may be eliminated if the interior post 365 is integrated into the connector body 360. Moreover, where the connector body 360 is formed with an interior wall 366 forming an unbroken surface between the exterior shell or casing 364 and the interior post 364, the number of potential ground points between the pulled back braided shield 324 of a coaxial cable 320 (shown in FIG. 23) and the connector 300 is increased. An increased number of potential ground points results in a potential for improved RF shielding and reduction in noise ingress into the connector 300. Additionally, the interior wall 366 may define and provide a boundary on the axial depth of the of the opening or ringed bore 363 extending from the first end 361 of the connector body 360.

The embodiments shown and described in FIGS. 1-22 may also be present in FIGS. 23-26, wherein they would employ integral structuring between the exterior shell or casing 364 and interior post 365 of connector body 360. Furthermore, as shown in FIG. 25, the second end 362 of an embodiment of the connector body 360 may include a ringed flange 367.

With reference to FIG. 26, a cut-away perspective view of a connector 300 is depicted, wherein the connector is in a first preinstalled configuration 390. The configuration may comprise the fastener member 340 positioned such that the first end 342 of the fastener member 340 is press fit onto the first end 361 of the connector body 360. The press fit may be such that once the fastener member 340 is positioned onto the connector body 360, the two components remain fitted via surface friction forces generated by the fitted contact of the components. The first preinstalled configuration 390 of the connector 300 may be such that there is minimal deformation of the exterior shell or casing 364 of the connector body 360 as a result of the press fit of the fastener member 340 onto the connector body 360. For example, where the fastener member 340 comprises a first opening or inner bore 347 having a taper, the exterior shell or casing 364 of the connector body 360 may be slidingly pressed into the fastener member 340 until the exterior shell or casing 364 begins to slightly deform because of contact with the first opening or inner bore 347. Moreover, if the fastener member 340 comprises a first opening or inner bore 347 having a constant diameter, the exterior shell 364 of the connector body 360 may be slidingly pressed into the fastener member 340 until the exterior shell 364 begins to slightly deform because of contact with the ramped surface 346 extending between the constant diameter first opening or inner bore 347 and larger diameter second opening or inner bore 348 of the fastener member.

With further reference to FIG. 26, the first preinstalled configuration 390 of the connector 300 may comprise the threaded nut 380 positioned such that the internal lip 382 of the threaded nut 380 is axially interlocked with the ringed flange 367 on the second end 362 of the connector body 360. The interlocking of the ringed flange 367 and the internal lip 382 may be facilitated by a press and snap coupling of the components, wherein the threaded nut 380 and corresponding internal lip 382 is pressed onto and over the ringed flange of the connector body 360 thereby snapping the said components into an axially interlocked position. The internal lip 382 may have tapered lip edges to assist in the snap coupling and interlocking of the threaded nut 380 with the connector body 360. Once coupled, the threaded nut 380 may be free to spin and rotate axially while remaining interlocked with the connector body 360. Hence the threaded nut 380 may be threaded onto an interface port while the connector body 360 remains axially static.

In addition to friction fitting and snap coupling, other types of pre-installation may be employed such as integral molding in a pre-installation configuration with strategically weakened portions, scoring, abrading between parts, knurling, etc. It should be recognized by persons skilled in the art that the connector 300 may be manufactured without the threaded nut 380. Moreover, it should be recognized that the connector 300 and its various components such as the fastener member 340, connector body 360, and/or threaded nut 380 may be fabricated out of various materials suitable for coaxial connectors such as metals, polymers, glass, composites and the like. Furthermore, the manufacture of the connector 300 may be by any means corresponding to efficient connector production such as cutting, turning, milling, stamping, rolling, casting, welding, injection molding and the like. Additionally, it should be recognized that the connector 300 and its various components may be assembled in a first preinstalled configuration 390 by the manufacturer prior to consumer purchase or assembled by consumers prior to positioning the connector 300 on a coaxial cable 320.

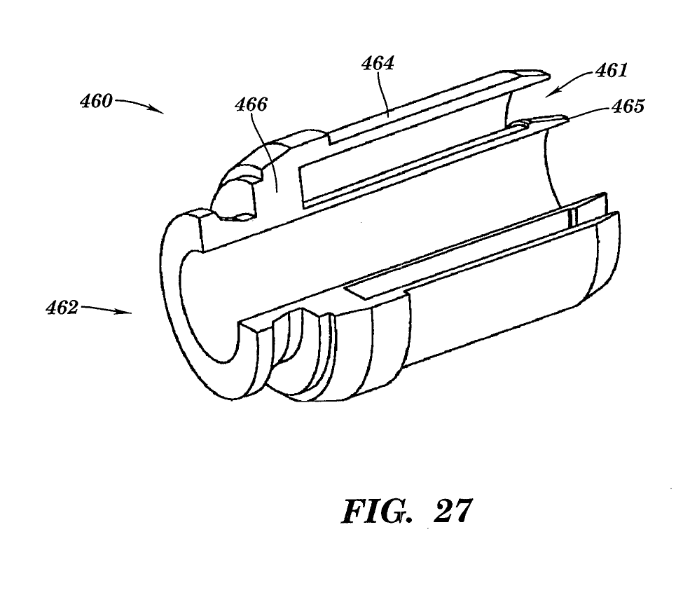

Referring now to FIG. 27, a cut-away perspective view of a connector body 460 of a connector according to one embodiment of the present invention is illustrated. The connector body 460 may comprise a first end 461 and axially opposing second end 462. The embodiment of connector body 460 may be similar to the embodied connector body 360 (depicted in FIG. 25). However, as pertaining to connector body 460, a portion of the interior post 465 may extend axially beyond the edge of the exterior casing or shell 464 at the first end 461 of the connector body 460. The extension of the interior post 465 beyond the edge of the exterior casing or shell 464 may facilitate manufacturing efficiencies. Like the interior post 365 of the embodiment of connector body 360, the interior post 465 embodied in connector body 460 may be adapted such that it may be inserted into an end of a coaxial cable 320 around the dielectric 326 and under the protective outer jacket 322 and corresponding braided shield 324 (see FIGS. 23 and 25). The particularly embodied connector body 460 may comprise an interior wall 466 formed integrally with exterior shell or casing 364 such that the integration facilitates a single mold, single machined piece, unitary, or single-body structured connector body 460 wherein the interior wall 466 defines and allows for an unbroken surface between the exterior shell or casing 464 and the interior post 465 of the connector body 460. A method of positioning the connector of FIG. 14 on a coaxial cable is now described with reference to FIGS. 14-20 and FIG. 22. The end of a coaxial cable is prepared as discussed above with respect to the connector of FIGS. 1-6. Then, the prepared end of the coaxial cable is inserted through the second opening 264 of fastener member 228 such that the central core portion comprising the center conductor 14, insulator core 20, and foil 18 is inserted into the first inner cavity 236 of post member 226. Also, the outer portion of the cable comprising outer braid conductor 16 folded over the end of the outer sheath jacket 22 is received into the first outer cavity 238 through opening 240.

The insulator core 20 and foil 18 of the cable is then axially displaced within the post member to ridge 274. The ridge is positioned such that the exposed end of the center conductor 14 protrudes beyond the second opening 234 of the post member, while the insulator core 20 portion and foil 18 of the cable is prevented from being displaced through second opening 234 of the post member.

Once the insulator core and foil of the cable is positioned to abut ridge 274 of the post member, the fastener member 228 is then advanced axially from its pre-installed first configuration to its second configuration by a standard tool. In this second configuration, the detent 248 of the fastener member can be secured by groove 250 formed between the nut member and the connector body.

As discussed above, the second inner bore 258 of fastener member 228 is dimensioned to concentrically compress the connector body so that the volume of the outer first cavity is decreased. That is, the connector body is deformed radially inwardly. As a result, the outer portion of the cable is firmly clamped between the outer surface of post member 226 and connector body 224. In this manner, in the preferred embodiment, the post member cooperates with the annular serrations 244 of the connector body to provide a generally continuous, 360° seal and grip on the outer portion of the cable. Advantageously, like the connector of FIGS. 1-6, this construction eliminates the need for an O-ring or other seal between the connector body and the fastener member, and can accommodate a wide range of cable types and sizes.

Once the fastener member is in its second configuration, nut 230 may then be employed to attach the connector to a system component—typically a threaded port or the like.

A method of improving RF shielding and reducing noise ingress into the coaxial cable connector 300 of FIG. 23 is now described with reference to FIGS. 23-27. A connector 300 in a first preinstalled position 390 is provided as shown in FIG. 26. The provision of the connector 300 in a first preinstalled configuration 390 may be facilitated by a manufacturer or distributor of the connector 300. Moreover, it should be recognized that the connecter 300 may be purchased by a consumer who assembles the connector 300 and provides an appropriate first preinstalled configuration 390. An end of the coaxial cable 320, as shown in FIG. 23, is prepared to receive the connector 300 by selectively removing various layers to progressively expose and separate an end of the center conductor 328 and an end of the dielectric 326 as illustrated with the end portion of the braided shield 324 folded back over the protective outer jacket 322. Preparation of the coaxial cable 320 may vary according to cable type and size.

Once the connector 300 has been provided and the coaxial cable 320 has been prepared, the prepared end of the coaxial cable 320 may be inserted through the fastener member 340 and into the connector body 360 such that the interior post 365 of the connector body 360 is slidingly positioned around the dielectric 326 and under the braided shield 324 and protective outer jacket 322. The coaxial cable 320 is advanced into the connector body 360 and onto the interior post 365. When the coaxial cable is advanced onto the connector body 360, electrical conductivity may extend from the cable 320 through the connector as the conductive elements of the cable contact the connector body 360. The cable 320 may be advanced until the folded-back braided shield 324 abuts, contacts and/or presses against the surface of the interior wall 366 of the connector body 360. The contact of the braided shield 324 with the connector body 360 facilitates grounding through the connector. Moreover, because of the unitary, single-bodied structuring of the exterior shell or casing 364 and interior post 365 of the connector body 360 (or similar structuring of other embodiments such as connector body 460), more substantial electrical contact can be made with the braided shield 324 resulting in improved RF shielding and reduction in noise ingress into the connector 300. For instance, the unbroken surface of connector body 360 substantially surrounds the braided shield 324 when the prepared coaxial cable 320 is inserted into the connector body 360 decreasing the potential for noise entry and increasing the potential number of electrical contact points between the coaxial cable 320 and the connector 300. Where the coaxial cable 320 has been prepared correctly, the center conductor 328 will extend out through the second end 362 of the connector body 360.

With the prepared coaxial cable 320 inserted into and onto the connector 300 in a first preinstalled configuration 390, the fastener member 340 may be forcibly slidingly advanced axially toward the second end 362 of the connector body 360. Accordingly, the fastener member 340 may be moved to a second configuration such that the fastener member 340 coacts with the exterior shell or casing 364 of the connector body 360 by compressing and deforming the exterior shell or casing 364 radially inwardly toward the interior post 365 of the connector body 360. Additionally, advancement of the fastener member 340 causes the volume of the opening 363 such as a molded cavity or ringed bore to decrease because the fastener member 340 is formed to constrict exterior shell or casing 364 of the connector body 360 thereby decreasing the volume of the opening 363. As the exterior shell or casing 364 is compressed, it tightens against the protective outer jacket 322 of the coaxial cable 320 causing a secured frictional sealing compression grip on the coaxial cable 320. Moreover, as a result of the sliding advancement of the fastener member 340, the deformation and compression of the exterior shell or casing 364 may cooperate with the interior post 365 of the connector body 360 to provide a generally continuous, 360° seal and grip on the outer portion of the coaxial cable 320. Advantageously, this construction eliminates the need for an O-ring or other seal between the connector body 360 and the fastener member 340, and can accommodate a wide range of cable types and sizes. Furthermore, because the connector body 360 is unitarily structured and there is no potential breach between the interface of the integral exterior casing or shell 364 and the interior post 365, moisture cannot enter into the connection once it is sealed preventing corrosion or other problems that may decrease grounding, disrupt electrical shielding or increase unwanted electromagnetic noise ingress into the connector.

An embodiment of the connector 300 may allow the fastener member 340 to slidingly move from the first preinstalled configuration 390 toward the second end 362 of the connector body 360 without rotation. Once the fastener member 340 is in its second configuration, the free spinning threaded nut 380 may then be employed to attach the connector 300 to a system component interface port—typically a threaded port or the like.

With further reference to the drawings, FIGS. 23-27 illustrate a method of improving RF shielding and reducing noise ingress into a coaxial cable connector having a connector body and interior post. To avoid problems of moisture, corrosion, and electromagnetic noise ingress, the interior post may be integrally formed with the connector body. The integration of the two components into a single structure results in simultaneously providing for improved RF shielding and reduction in noise ingress into the connector because of the unitary, single-bodied structuring of the connector body 360, an unbroken surface between the exterior shell or casing 364 and the interior post 364, increases the number of potential ground points between the pulled back braided shield 324 of coaxial cable 320. This results in more substantial electrical contact made with the braided shield 324 of an inserted coaxial cable 320 resulting in improved RF shielding and reduction in noise ingress into the connector 300.

To further reduce noise and improve RF shielding a coaxial cable may be securely sealed into the connector 300. When the cable is sealed into the connector 300, moisture cannot enter it, thereby preventing corrosion or other problems that may decrease grounding, disrupt electrical shielding or increase unwanted electromagnetic noise ingress into the connector. Moreover, improved RF shielding and reduction in electromagnetic noise ingress into the connector 300 further results because the connector body 360 is unitarily structured and therefore there is no potential environmental breach between the interface of the integral exterior casing or shell 364 and the interior post 365. Still further noise reduction and RF shielding may be accomplished by attaching the connector to an interface port.

While the present invention has been described and illustrated herein with respect to preferred embodiments, it should be apparent that various modifications, adaptations and variations may be made utilizing the teachings of the present disclosure without departing from the scope of the invention and are intended to be within the scope of the present invention. In light of the foregoing, it will now be appreciated by those skilled in art that modifications may be made to the disclosed embodiments without departing from the spirit and scope of the invention as defined by the appended claims.

1. A connector for coupling an end of a coaxial cable to an interface port, the coaxial cable having a center conductor surrounded by a dielectric, the dielectric being surrounded by a protective outer jacket, said connector comprising:
a. a connector body for receiving the coaxial cable, wherein the connector body includes a first end, the first end including an opening defined by an exterior casing and an integral interior post, the post adapted to be inserted into an end of the coaxial cable around the dielectric and under the protective outer jacket thereof; and,
b. a fastener member, wherein the fastener member causes the exterior casing of the connector body to be deformed inwardly toward the interior post of the connector body and against the protective outer jacket of the coaxial cable as received and as the fastener member is advanced over the connector body.

2. The connector of claim 1, wherein the opening is a ringed bore and is bounded by an interior wall facilitating integral structuring of the exterior shell and interior post of the connector body.

3. The connector of claim 1, further wherein the connector body comprises a second end, the second end having ringed flange.

4. The connector of claim 3, wherein the fastener member comprises a first end and opposing second end with a central passageway defined between the fastener member first end and the fastener member second end for allowing a portion of the coaxial cable to pass there through, the fastener member secured to the connector body prior to installation over said end of the coaxial cable in a preinstal led first configuration, the central passageway being dimensioned to compress the connector body radially inwardly when the fastener member is slidingly moved from the first preinstalled configuration toward the second end of the connector body.

5. The connector of claim 4, wherein the central passageway of the fastener member includes a ramped surface.

6. The connector of claim 5, wherein the central passageway of the fastener member further includes a first opening having a first diameter proximate with the first end and a second opening having a second diameter proximate with the second end, the second opening diameter being less than the first opening diameter, and wherein the ramped surface is positioned between the first opening and the second opening.

7. The connector of claim 6, wherein the first opening of the fastener member is dimensioned to radially compress the exterior casing of the first end of the connector body inwardly when the fastener member is in the first preinstalled configuration.

8. The connector of claim 6, wherein the first opening of the fastener member is dimensioned to provide a press-fit between the first end of the connector body and the fastener member when the fastener member is in the first preinstalled configuration.

9. The connector of claim 6, wherein the first opening has a constant diameter.

10. The connector of claim 6, wherein the first opening is tapered.

11. The connector of claim 4, wherein the fastener member is slidingly moved from the first preinstalled configuration toward the second end of said connector body without rotation.

12. The connector of claim 1, further comprising a threaded nut.

13. The connector of claim 12, wherein the threaded nut comprises an internal lip.

14. A connector for coupling an end of a coaxial cable to an interface port, the coaxial cable having a center conductor surrounded by a dielectric, the dielectric being surrounded by a protective outer jacket, said connector comprising:
a. a connector body for receiving the coaxial cable, wherein the connector body includes a first end and a second end, the first end including an opening partially defined by an unbroken surface extending between an exterior casing and an interior post, the post adapted to be inserted into an end of the coaxial cable around the dielectric and under the protective outer jacket thereof, the second end having a ringed flange; and,
b. a fastener member having a first end and opposing second end with a central passageway defined between the fastener member first end and the fastener member second end for allowing a portion of the coaxial cable to pass there through, the fastener member secured to the connector body prior to installation over the end of the coaxial cable in a preinstalled first configuration, the central passageway being dimensioned to compress the connector body radially inwardly when the fastener member is slidingly moved from the first preinstalled configuration toward the second end of the connector body, wherein the fastener member causes the exterior casing of the connector body to be deformed inwardly toward the interior post of the connector body and against the protective outer jacket of the coaxial cable as received and as the fastener member is advanced over the connector body.

15. The connector of claim 14, wherein the opening is a ringed bore and is bounded by an integral interior wall facilitating the unbroken surface extending between the exterior casing and interior post of the connector body.

16. The connector of claim 14, wherein the central passageway of the fastener member includes a ramped surface.

17. The connector of claim 5, wherein the central passageway of the fastener member further includes a first inner bore having a first diameter proximate with the first end and a second inner bore having a second diameter proximate with the second end, the second inner diameter being less than the first inner diameter, and wherein the ramped surface is positioned between the first inner bore and the second inner bore.

18. The connector of claim 17, wherein the first inner bore of the fastener member is dimensioned to radially compress the exterior casing of the first end of the connector body inwardly when the fastener member is in the first preinstalled configuration.

19. The connector of claim 17, wherein the first inner bore of the fastener member is dimensioned to provide a press-fit between the first end of the connector body and the fastener member when the fastener member is in the first preinstalled configuration.

20. The connector of claim 17, wherein the first inner bore has a constant diameter.

21. The connector of claim 17, wherein the first inner bore is tapered.

22. The connector of claim 14, wherein the fastener member is slidingly moved from the first preinstalled configuration toward the second end of said connector body without rotation.

23. The connector of claim 14, further comprising a threaded nut.

24. The connector of claim 23, wherein the threaded nut comprises an internal lip.

25. A method of improving RF shielding and reducing noise ingress into a coaxial cable connector having a connector body and a post, said method comprising:
providing the post integral with the connector body, whereby the integration results in simultaneously providing for improved RF shielding and reduction in noise ingress into the connector.

26. The method of claim 25 further comprising a step of securely sealing a coaxial cable into the connector.

27. The method of claim 25 further comprising a step of attaching the connector to an interface port.

28. A method of improving RF shielding and reducing noise ingress into a coaxial cable connector, said method comprising:
a providing a connector, said connector including:
a1. a unitary connector body for receiving the coaxial cable, wherein the unitary connector body includes an exterior casing and an interior post,
a2. a fastener member, wherein the fastener member causes the opening of the connector body to be decreased as the fastener member is advanced over the connector body;
b. inserting a coaxial cable end through the fastener member and onto the connector body, wherein the connector body facilitates improved RF shielding and reduction of noise ingress into the connector; and
c. advancing the fastener member from a first preinstalled configuration to a second configuration such that a continuous seal and secure grip is formed between the connector and the coaxial cable.
